(19) United States
(12) Patent Application Publication
(10) Pub. No.: US 2014/0287251 A1
(43) Pub. Date: Sep. 25, 2014

(54) PZT-BASED FERROELECTRIC THIN FILM-FORMING COMPOSITION, METHOD OF PREPARING THE SAME, AND METHOD OF FORMING PZT-BASED FERROELECTRIC THIN FILM USING THE SAME

(71) Applicant: MITSUBISHI MATERIALS CORPORATION, Tokyo (JP)

(72) Inventors: Toshihiro Doi, Naka-gun (JP); Hideaki Sakurai, Naka-gun (JP); Nobuyuki Soyama, Naka-gun (JP)

(73) Assignee: MITSUBISHI MATERIALS CORPORATION, Tokyo (JP)

(21) Appl. No.: 14/183,746

(22) Filed: Feb. 19, 2014

(30) Foreign Application Priority Data
Mar. 25, 2013 (JP) 2013-061938

(51) Int. Cl. C23C 18/12; B05D 3/02

(52) U.S. Cl. CPC C23C 18/1216; B05D 3/0254
USPC 428/457; 427/123; 524/382; 523/333

(57) ABSTRACT

This PZT-based ferroelectric thin film-forming composition comprises: a PZT precursor; a diol; one of polyvinyl pyrrolidones and a polyethylene glycol; water, and a linear monoalcohol having 6 to 12 carbon chains. In this composition, a concentration of the PZT precursor in 100 wt % of the composition is 17 wt % to 35 wt % in terms of oxides, the ratio of the diol to 100 wt % of the composition is 16 wt % to 56 wt %, the ratio of the one of the polyvinyl pyrrolidones and the polyethylene glycol to 1 mol of the PZT precursor is 0.01 mol to 0.25 mol, the ratio of the water to 1 mol of the PZT precursor is 0.5 mol to 3 mol, and the ratio of the linear monoalcohol to 100 wt % of the composition is 0.6 wt % to 10 wt %.

### BACKGROUND OF THE INVENTION

1. Field of the Invention

The present invention relates to a PZT-based ferroelectric thin film-forming composition, a method of preparing the composition, and a method of forming a PZT-based ferroelectric thin film using the composition. Specifically, the invention relates to a composition used to form a PZT-based ferroelectric thin film, which is used for a dielectric layer or the like of a thin film capacitor, using a sol-gel method; a method of preparing the composition; and a method of forming a PZT-based ferroelectric thin film using the composition. More specifically, the invention relates to a PZT-based ferroelectric thin film-forming composition capable of obtaining, even when the thickness of a coating film formed for each coating process is relatively thick, a dense and high-performance thin film without voids and cracks and capable of being crystallized by performing a baking process once.

Priority is claimed on Japanese Patent Application No. 2013-61938, filed on Mar. 25, 2013, the content of which is incorporated herein by reference.

2. Description of Related Art

A ferroelectric thin film used for a dielectric layer of a thin film capacitor or the like is a type of thin film, but it is necessary that this ferroelectric thin film have a certain level of thickness to obtain enough reliability to endure use. In addition, in a device or the like in which the occupied area of a capacitor or the like can be secured to a certain degree, a relatively thick film can be formed without sacrificing the thickness of a dielectric layer. However, in a sol-gel method, typically, a high-temperature process such as pre-baking or baking is performed. Therefore, when an attempt to obtain a thicker film is made by increasing the coating amount for each coating process, tensile stress generated in the film during baking or the like is increased, which may cause a problem of cracking in the formed film.

When cracking occurs in the formed film, the electrical properties or the like of the ferroelectric thin film deteriorate. In the related art, the thickness of a film which can be formed for each coating process using a sol-gel method is limited to about 100 nm. In order to form a thick ferroelectric thin film, a method used to perform coating and baking processes of a composition multiple times is adopted. However, with this method, production efficiency decreases, which leads to an increase in film forming cost. Therefore, studies and developments have been actively made regarding improvement of a material, that is, regarding a raw material solution capable of increasing the thickness of a film formed in each coating process without cracking.

For example, Japanese Unexamined Patent Application, First Publication No. 2001-261338 (claim 1, paragraphs [0015] to [0024], Table 1) discloses a metal oxide thin film-forming raw material solution used to form a Ti-containing metal oxide thin film, in which propylene glycol is added to the raw material solution. Using this raw material solution, a film having a thickness of 0.2 μm or greater can be formed for each coating process without cracking. In addition, disclosed is a method capable of increasing the thickness of a film formed for each coating process without cracking, in which a high-molecular compound is added to a high-concentration sol-gel solution to release tensile stress generated during film formation (for example, refer to J Sol-Gel Sci Technol (2008) 47:316 to 325).

### SUMMARY OF THE INVENTION

### Technical Problem

In the raw material solutions disclosed in Japanese Unexamined Patent Application, First Publication No. 2001-261338 and J Sol-Gel Sci Technol (2008) 47:316 to 325, cracking can be prevented to some extent by the addition of the propylene glycol and the high-molecular compound; however, in order to form a film having practically sufficient properties, it is necessary that cracking be further suppressed and a film having a dense structure be formed. Therefore, there is room for further improvement. In addition, there is also room for further improvement in simplifying a film-forming process during the formation of a relatively thick film and in reducing cost. Further, since voids are formed in a film, it is difficult to form a dense and high-performance PZT film sufficient for industrial use.

An object of the invention is to provide a PZT-based ferroelectric thin film-forming composition capable of obtaining, even when the thickness of a coating film formed for each coating process is relatively thick, a dense and high-performance thin film without voids and cracks and capable of being crystallized by performing a baking process once; a method of preparing the composition; and a method of forming a PZT-based ferroelectric thin film using the composition.

### Solution to Problem

According to a first aspect of the invention, there is provided a PZT-based ferroelectric thin film-forming composition used to form a PZT-based ferroelectric thin film, the composition including: a PZT precursor; a diol; one of polyvinyl pyrrolidones and a polyethylene glycol; water; and a linear monoalcohol having 6 to 12 carbon chains, in which a concentration of the PZT precursor in 100 wt % of the composition is 17 wt % to 35 wt % in terms of oxides, the ratio of the diol to 100 wt % of the composition is 16 wt % to 56 wt %, the ratio of the one of the polyvinyl pyrrolidones and the polyethylene glycol to 1 mol of the PZT precursor is 0.01 mol to 0.25 mol in terms of monomers, the ratio of the water to 1 mol of the PZT precursor is 0.5 mol to 3 mol, and the ratio of the linear monoalcohol having 6 to 12 carbon atoms to 100 wt % of the composition is 0.6 wt % to 10 wt %.

According to a second aspect of the invention, there is provided a method of preparing a PZT-based ferroelectric thin film-forming composition, the method including: a step of mixing a PZT precursor which has a concentration of 17 wt % to 35 wt % in terms of oxides in 100 wt % of the composition, a diol which has a ratio of 16 wt % to 56 wt % with respect to 100 wt % of the composition, and water which has a ratio of 0.5 mol to 3 mol with respect to 1 mol of the PZT precursor to react with each other to prepare a synthetic solution; a step of refluxing the synthetic solution at a temperature of 130° C. to 175° C. for 0.5 hours to 3 hours; a step of adding a linear monoalcohol having 6 to 12 carbon chains, which has a ratio of 0.6 wt % to 10 wt % with respect to 100 wt % of the composition, to the refluxed synthetic solution to prepare a sol-gel solution; a step of re-refluxing the sol-gel solution at a temperature of 100° C. to 175° C. for 0.5 hours to 10 hours; and a step of adding one of polyvinyl pyrrolidones and a polyethylene glycol, which has a ratio of 0.01 mol to 0.25 mol with respect to 1 mol of the PZT precursor, to the re-refluxed sol-gel solution to be uniformly dispersed in the sol-gel solution.

According to a third aspect of the invention, in the composition according to the first aspect, it is preferable that the diol be one of a propylene glycol and an ethylene glycol.

According to a fourth aspect of the invention, in the method according to the second aspect, it is preferable that the diol be one of a propylene glycol and an ethylene glycol.

According to a fifth aspect of the invention, there is provided a method of forming a PZT-based ferroelectric thin film, the method including: coating the PZT-based ferroelectric thin film-forming composition according to the first aspect or a PZT-based ferroelectric thin film-forming composition prepared using the method according to the second aspect on a lower electrode of a substrate; pre-baking the composition; and baking the composition to be crystallized and to form a thin film on the lower electrode.

According to a sixth aspect of the invention, there is provided a complex electronic component including: a PZT-based ferroelectric thin film which is formed using the method according to the fifth aspect, in which the complex electronic component is one of a thin film capacitor, a capacitor, an IPD, a DRAM memory capacitor, a laminated capacitor, a gate insulator of a transistor, a non-volatile memory, a pyroelectric infrared detecting element, a piezoelectric element, an electro-optic element, an actuator, a resonator, an ultrasonic motor, and an LC noise filter element.

### Advantageous Effects of Invention

The PZT-based ferroelectric thin film-forming composition according to the first aspect of the invention includes: a PZT precursor; a diol; one of polyvinyl pyrrolidones and a polyethylene glycol; water; and a linear monoalcohol having 6 to 12 carbon chains, in which the concentration of the PZT precursor in 100 wt % of the composition is 17 wt % to 35 wt % in terms of oxides, and the ratio of the diol to 100 wt % of the composition is 16 wt % to 56 wt %. In addition, the ratio of the one of the polyvinyl pyrrolidones and the polyethylene glycol to 1 mol of the PZT precursor is 0.01 mol to 0.25 mol in terms of monomers, the ratio of the water to 1 mol of the PZT precursor is 0.5 mol to 3 mol, and the ratio of the linear monoalcohol having 6 to 12 carbon atoms to 100 wt % of the composition is 0.6 wt % to 10 wt %. As a result, in a case where this composition is used to form a ferroelectric thin film with a sol-gel method, a dense and high-performance thin film can be formed without voids and cracking even when the thickness of a coating film formed for each coating process is relatively large at 100 nm to 250 nm. In addition, even when the thickness of a coating film formed by coating the composition twice is relatively large at 200 nm to 500 nm, the coating film can be crystallized by baking the coating film once. Further, since the amount of polyvinyl pyrrolidone or polyethylene glycol is relatively small, a high-temperature process during film formation can be simplified, and production efficiency can be improved. In addition, an effect of decreasing the residual stress of a film can be obtained.

The method of preparing a PZT-based ferroelectric thin film-forming composition according to the second aspect of the invention includes: a step of mixing a PZT precursor which has a concentration of 17 wt % to 35 wt % in terms of oxides in 100 wt % of the composition, a diol which has a ratio of 16 wt % to 56 wt % with respect to 100 wt % of the composition, and water which has a ratio of 0.5 mol to 3 mol with respect to 1 mol of the PZT precursor to react with each other to prepare a synthetic solution; a step of refluxing the synthetic solution at a temperature of 130° C. to 175° C. for 0.5 hours to 3 hours; a step of adding a linear monoalcohol having 6 to 12 carbon chains, which has a ratio of 0.6 wt % to 10 wt % with respect to 100 wt % of the composition, to the refluxed synthetic solution to prepare a sol-gel solution; a step of re-refluxing the sol-gel solution at a temperature of 100° C. to 175° C. for 0.5 hours to 10 hours; and a step of adding one of polyvinyl pyrrolidones and a polyethylene glycol, which has a ratio of 0.01 mol to 0.25 mol with respect to 1 mol of the PZT precursor, to the re-refluxed sol-gel solution to be uniformly dispersed in the sol-gel solution. In the preparation method according to the invention, since the amount of polyvinyl pyrrolidone or polyethylene glycol is decreased by appropriate hydrolysis, a composition capable of simplifying a high-temperature process during film formation and improving production efficiency can be obtained.

The PZT-based ferroelectric thin film-forming composition according to the third aspect of the invention contains one of a propylene glycol and an ethylene glycol as the diol and thus is superior in storage stability.

In the method of preparing a PZT-based ferroelectric thin film-forming composition according to the fourth aspect of the invention, since one of a propylene glycol and an ethylene glycol is used as the diol, a composition which has a high viscosity and is superior used to form a thick film can be obtained.

The method of forming a PZT-based ferroelectric thin film according to the fifth aspect of the invention includes: coating the above-described PZT-based ferroelectric thin film-forming composition according to the invention or a PZT-based ferroelectric thin film-forming composition prepared using the above-described method according to the invention on a lower electrode of a substrate; pre-baking the composition; and baking the composition to be crystallized and to form a thin film on the lower electrode. In this method, the above-described PZT-based ferroelectric thin film-forming composition according to the invention or a PZT-based ferroelectric thin film-forming composition prepared using the above-described method according to the invention is used. Therefore, even when the thickness of a coating film formed for each coating process is relatively large at 100 nm to 250 nm, a dense and high-performance thin film can be obtained without voids and cracks. In addition, even when the thickness of a coating film formed by coating the composition twice is relatively large at 200 nm to 500 nm, the coating film can be crystallized by baking the coating film once. Further, since the amount of polyvinyl pyrrolidone or polyethylene glycol in the composition used in the method is relatively small, a high-temperature process during film formation can be simplified, and production efficiency can be improved. In addition, since this method easily promotes the densification of a film structure, production efficiency can be increased.

The thin film capacitor or the like according to the sixth aspect includes a PZT-based ferroelectric thin film which is formed using the above-described method according to the invention and which has a dense structure in which an extremely small amount of voids and cracks are formed, whereby the electrical properties and the service life reliability thereof are superior.

### BRIEF DESCRIPTION OF THE DRAWINGS

FIGS. 1A to 1E are diagrams schematically illustrating a mechanism of preventing voids from being formed during the formation of a film using a solution of a PZT-based ferroelectric thin film-forming composition according to an embodiment of the invention.

FIGS. 2A to 2E are diagrams schematically illustrating a mechanism of voids being formed during the formation of a film using a solution of a PZT-based ferroelectric thin film-forming composition according to an example of the related art.

FIG. 3 is a graph illustrating an example of a temperature profile in a high-temperature process during the formation of a thin film according to an example of the invention.

FIG. 4 is an image obtained by observing a cross-section of a PZT-based ferroelectric thin film obtained in Example 1 with a scanning electron microscope (SEM).

FIG. 5 is an image obtained by observing a cross-section of a PZT-based ferroelectric thin film obtained in Example 22 with an SEM.

FIG. 6 is an image obtained by observing a cross-section of a PZT-based ferroelectric thin film obtained in Comparative Example 1 with an SEM.

### DETAILED DESCRIPTION OF THE INVENTION

Hereinafter, embodiments of the invention will be described based on the drawings.

A composition according to an embodiment of the invention is an improvement of a composition used to form a PZT-based ferroelectric thin film. As a characteristic configuration, the composition includes: a PZT precursor, a diol; one of polyvinyl pyrrolidones and a polyethylene glycol; water; and a linear monoalcohol having 6 to 12 carbon chains, in which a concentration of the PZT precursor in 100 wt %/o of the composition is 17 wt % to 35 wt % in terms of oxides, the ratio of the diol to 100 wt % of the composition is 16 wt % to 56 wt %, the ratio of the one of polyvinyl pyrrolidones and the polyethylene glycol to 1 mol of the PZT precursor is 0.01 mol to 0.25 mol in terms of monomers, the ratio of the water to 1 mol of the PZT precursor is 0.5 mol to 3 mol, and the ratio of the linear monoalcohol having 6 to 12 carbon atoms to 100 wt % of the composition is 0.6 wt % to 10 wt %.

A PZT-based ferroelectric thin film formed of the composition according to the embodiment is configured by a Pb-containing composite metal oxide having a perovskite structure such as lead zirconate titanate (PZT) or PLZT obtained by adding La to PZT. The PZT precursor contained in the composition is a raw material used to form the above-described composite metal oxide or the like in the formed ferroelectric thin film, and this PZT precursor is contained in the composition such that a desired metal atomic ratio is obtained in PZT or PLZT. Specifically, when the PZT precursor is represented by the formula “(PbₓLa_{y})(ZrᵣTi_{1-Z})O₃”, it is preferable that the metal atomic ratio be adjusted such that x, y, and z satisfy 1.00<x<1.25, 0y<0.05, and 0.4<z<0.6, respectively. In addition, the PZT-based ferroelectric thin film may also contain, for example, PMnZt to which Mn is added or PNbZT to which Nb is added.

As a material of the PZT precursor, a compound in which an organic group binds to a metal element such as Pb, La, Zr, and Ti through an oxygen or nitrogen atom of the organic group is preferable. Examples of such a compound include one or two or more elements selected from the group consisting of metal alkoxides, metal diol complexes, metal triol complexes, metal carboxylates, metal β-diketonate complexes, metal β-diketoester complexes, metal β-iminoketo complexes, and metal amino complexes. Particularly preferable compounds are metal alkoxides, and partial hydrolysates and organic acid salts thereof.

Specifically, examples of a Pb compound and a La compound include acetates such as lead acetate: Pb(OAc)₂ or lanthanum acetate: La(OAc)₃; and alkoxides such as lead diisopropoxide: Pb(OiPr)₂ or lanthanum triisopropoxide: La(OiPr)₃. Examples of a Ti compound include alkoxides such as titanium tetraethoxide: Ti(OEt)₄, titanium tetraisopropoxide: Ti(OiPr)₄, titanium tetra n-butoxide: Ti(OnBu)₄, titanium tetraisobutoxide: Ti(OiBu)₄, titanium tetra t-butoxide: Ti(OtBu)₄, or titanium dimethoxy diisopropoxide: Ti(OMe)₂(OiPr)₂. As a Zr compound, the same alkoxides as those of the Ti compound are preferable. Metal alkoxides may be used without any change, but partial hydrolysates thereof may be used in order to promote decomposition. In addition, examples of a Mn compound include manganese acetate, manganese 2-ethylhexanoate, and manganese naphthenate. In addition, examples of an Nb compound include niobium pentaethoxide and niobium 2-ethylhexanoate.

The reason for limiting the concentration of the PZT precursor in 100 wt % of the composition to be 17 wt % to 35 wt % in terms of oxides is as follows. When the concentration is lower than the lower limit, a sufficient film thickness cannot be obtained. On the other hand, when the concentration is higher than the upper limit, cracking is likely to occur. The concentration of the PZT precursor in 100 wt % of the composition is more preferably 20 wt % to 25 wt % in terms of oxides. The concentration of the PZT precursor in the composition in terms of oxides refers to the concentration of metal oxides in 100 wt % of the composition which is calculated under the assumption that all the metal elements contained in the composition are converted into desired oxides.

The diol contained in the composition is a component constituting a solvent of the composition. Specific examples of the diol include propylene glycol, ethylene glycol, and 1,3-propanediol. Among these, propylene glycol or ethylene glycol is preferable. By using the diol as an essential solvent component, the storage stability of the composition can be increased.

The reason for limiting the ratio of the diol to 100 wt % of the composition to be 16 wt % to 56 wt % is as follows. When the ratio is lower than the lower limit, precipitates may be formed. On the other hand, when the ratio is higher than the upper limit, voids (micropores) are likely to be formed during the formation of a thick film. The ratio of the diol is more preferably 28 wt % to 42 wt %.

In addition, as other solvents, carboxylic acids, alcohols (for example, ethanol, 1-butanol, or polyols other than diol), esters, ketones (such as acetone or methyl ethyl ketone), ethers (such as dimethylether or diethylether), cycloalkanes (such as cyclohexane or cyclohexanol), aromatic compounds (such as benzene, toluene, or xylene) or tetrahydrofuran; or mixed solvents obtained by adding one or two or more of the above-described solvents to diol can be used.

Preferable examples of carboxylic acids include n-butyric acid, α-methylbutyric acid, i-valeric acid, 2-ethylbutyric acid, 2,2-dimethylbutyric acid, 3,3-dimethylbutyric acid, 2,3-dimethylbutyric acid, 3-methylpentanoic acid, 4-methylpentanoic acid, 2-ethylpentanoic acid, 3-ethylpentanoic acid, 2,2-dimethylpentanoic acid, 3,3-dimethylpentanoic acid, 2,3-dimethylpentanoic acid, 2-ethylhexanoic acid, and 3-ethylhexanoic acid.

In addition, preferable examples of esters include ethyl acetate, propyl acetate, n-butyl acetate, sec-butyl acetate, tert-butyl acetate, isobutyl acetate, n-amyl acetate, sec-amyl acetate, tert-amyl acetate and isoamyl acetate. Preferable examples of alcohols include 1-propanol, 2-propanol, 1-butanol, 2-butanol, isobutyl alcohol, 1-pentanol, 2-pentanol, 2-methyl-2-pentanol, and 2-methoxyethanol.

In addition, the composition according to the embodiment contains, as a high-molecular compound, one of polyvinyl pyrrolidones (PVP) and a polyethylene glycol. Polyvinyl pyrrolidone and polyethylene glycol are used for adjusting the viscosity of the solution in the composition. In particular, polyvinyl pyrrolidone is used to adjust a relative viscosity determined based on a k value. “k value” described herein refers to a value representing a viscosity property, which correlates to a molecular weight, and is calculated according to the following Fikentscher's formula using a relative viscosity (25° C.) which is measured with a capillary viscometer.

k value=(1.5 log ηrel-1)/(0.15+0.003c) +(300c log ηrel+(c+1.5c log ηrel)²)^{1/2}(0.15c+0.003c²)

In the above formula, “ηrel” represents a relative viscosity of an aqueous polyvinyl pyrrolidone solution to water, and “c” represents a concentration (wt %) of polyvinyl pyrrolidone in an aqueous polyvinyl pyrrolidone solution.

The k value of polyvinyl pyrrolidone contained in the composition according to the embodiment is preferably 30 to 90. In order to form a thick ferroelectric thin film, when the composition is coated on a substrate or the like, a sufficient viscosity is necessary for maintaining the thickness of the coated coating film (gel film). However, when the k value is lower than the lower limit, it is difficult to obtain the sufficient viscosity. On the other hand, when the k value is higher than the upper limit, the viscosity is excessively high, and it is difficult to uniformly coat the composition. In addition, when polyethylene glycol is used, the polymerization degree thereof is preferably 200 to 400. When the polymerization degree is lower than the lower limit, it is difficult to obtain the sufficient viscosity. On the other hand, when the polymerization degree is higher than the upper limit, the viscosity is excessively high, and it is difficult to uniformly coat the composition. In addition, polyvinyl pyrrolidone is particularly preferable due to an effect of suppressing cracking.

The reason for limiting the ratio of the one of the polyvinyl pyrrolidones (PVP) and the polyethylene glycol to 1 mol of the PZT precursor to be 0.01 mol to 0.25 mol in terms of monomers is as follows. When the ratio is lower than the lower limit, cracking is likely to occur. On the other hand, when the ratio is higher than the upper limit, voids are likely to be formed. The ratio of the one of the polyvinyl pyrrolidones and the polyethylene glycol to 1 mol of the PZT precursor is more preferably 0.025 mol to 0.075 mol. The one of the polyvinyl pyrrolidones and the polyethylene glycol has a high decomposition temperature and high affinity to the PZT precursor and thus is difficult to remove from a film, which is likely to cause voids. Therefore, the smaller the addition amount, the better. In the composition according to the embodiment, since organic materials are easily removed from a film by appropriately hydrolyzing the precursor, the addition amount of one of the polyvinyl pyrrolidones (PVP) and the polyethylene glycol can be suppressed to be relatively low.

The value of “mol in terms of monomers” refers to the value of molecular weight using a monomer included in a high-molecular compound as a reference. The “mol in terms of monomers” to 1 mol of the PZT precursor refers to the ratio of molecular weight to 1 mol of the PZT precursor using a monomer included in a high-molecular compound as a reference.

In addition, the composition according to the embodiment contains water such as ion exchange water or ultrapure water. By the composition containing water at the predetermined ratio, the precursor is appropriately hydrolyzed, and thus an effect of improving the densification of a film structure can be obtained. The reason for limiting the ratio of water to 1 mol of the PZT precursor to be 0.5 mol to 3 mol is as follows. When the ratio is lower than the lower limit, hydrolysis is not sufficient, which may cause a problem of insufficient densification of a film structure or the like. On the other hand, when the ratio is higher than the upper limit, hydrolysis is excessively progressed, which may cause a problem of precipitates, cracking in a film, or the like. The ratio of water to 1 mol of the PZT precursor is more preferably 0.8 mol to 2 mol.

In addition, the composition according to the embodiment contains the linear monoalcohol having 6 to 12 carbon chains. By the composition containing the linear monoalcohol at the predetermined ratio, a gel film capable of efficiently discharging organic materials outside of the film during pre-baking can be formed. In addition, even when the thickness of a film is greater than 100 nm, a dense and high-performance PZT film can be obtained. The reason for limiting the number of carbon chains in the linear monoalcohol to be 6 to 12 is as follows. When the number of carbon chains is less than the lower limit, the boiling point is not sufficiently high, and a film cannot be sufficiently densified. When the number of carbon chains is more than the upper limit, a film is densified; however, the solubility in a sol-gel solution is low, it is difficult to dissolve a sufficient amount of the linear monoalcohol, and the viscosity of the solution is excessively increased. Therefore, uniform coating cannot be performed due to striation (thin streak, stripe) or the like. The number of carbon chains in the linear monoalcohol is more preferably 7 to 9. In addition, the reason for limiting the ratio of the linear monoalcohol to 100 wt % of the composition to be 0.6 wt % to 10 wt % is as follows. When the ratio is lower than the lower limit, sufficient gaps cannot be formed in a film, organic materials are not efficiently removed from the film during a process, and thus the densification of the film is not sufficiently progressed. On the other hand, when the ratio is higher than the upper limit, the drying of a film is delayed, a long time is required for drying, and the thickness of the film is small. The ratio of the linear monoalcohol to 100 wt % of the composition is more preferably 1 wt % to 3 wt %. In addition, the linear monoalcohol having 6 carbon chains is 1-hexanol, the linear monoalcohol having 7 carbon chains is 1-heptanol, the linear monoalcohol having 8 carbon chains is 1-octanol, and the linear monoalcohol having 9 carbon chains is 1-nonanol. In addition, the linear monoalcohol having 10 carbon chains is 1-decanol, the linear monoalcohol having 11 carbon chains is 1-undecanol, and the linear monoalcohol having 12 carbon chains is 1-dodecanol.

In addition to the above-described components, a stabilizer may be optionally added to the composition at a ratio (number of molecules of stabilizer)/(number of metal atoms) of about 0.2 to 3. Examples of the stabilizer include β-diketones (such as acetyl acetone, heptafluorobutanoyl pivaloyl methane, dipivaloyl methane, trifluoroacetyl acetone, or benzoyl acetone), 0-ketonic acids (such as acetoacetic acid, propionyl acetic acid, or benzoyl acetic acid), R-keto esters (such as methyl, propyl, butyl, and other lower alkyl esters of the above-described ketonic acids), oxy acids (such as lactic acid, glycolic acid, α-oxybutyric acid, or salicylic acid), lower alkyl esters of the above-described oxy acids, oxyketones (such as diacetone alcohol or acetoin), diols, triols, higher carboxylic acids, alkanol amines (such as diethanolamine, triethanolamine, or monoethanolamine), and polyvalent amines. Among these, acetyl acetone of 3-diketones is preferable as the stabilizer.

In addition, the composition according to the embodiment can contain a polar solvent such as a formamide-based solvent as an organic dopant. As the formamide-based solvent, any of formamide, N-methyl formamide, or N—N-dimethyl formamide is preferably used. In the composition according to the embodiment, since the PZT precursor is hydrolyzed, a thick film having a small amount of cracks can be formed without the addition of the formamide-based solvent or the like. On the other hand, by using the formamide-based solvent or the like in combination with the polyvinyl pyrrolidone and the like, a film having a smaller amount of cracks and a dense structure can be formed. In addition, when the composition is coated, a more uniform coating film can be formed, and an effect of promoting the removal of a solvent during baking can be further improved. Examples of an organic dopant other than the formamide-based solvent include an ethanolamines such as monoethanolamine or diethanolamine, and the ethanolamines can be used in combination with the formamide-based solvent. The ethanolamines has an effect of increasing the storage stability of the solution by being coordinated to a metal alkoxide. The ratio of the organic dopant containing the formamide-based solvent to 100 wt % of the composition is preferably 3 wt % to 13 wt %.

Further, the composition according to the embodiment can further contain a metal dopant such as lanthanum (La), manganese (Mn), or niobium (Nb). It is preferable that the metal dopant having a low concentration of 0.002 mol to 0.03 mol with respect to 1 mol of Pb in a Pb source of the PZT precursor be added to the composition according to the embodiment. By the composition containing the metal dopant at the predetermined ratio, for example, the effects of reducing a leakage current, improving a dielectric constant, improving electrical properties, and improving a mechanical quality factor (constant indicating the sharpness of mechanical vibration near a resonance frequency when a piezoelectric element or the like naturally vibrates) can be obtained. The reason for limiting the ratio of the metal dopant added to be 0.002 mol to 0.03 mol is as follows. When the ratio is lower than the lower limit, a doping effect is not sufficiently obtained. When the ratio is higher than the upper limit, a heterogeneous phase is likely to be precipitated, and piezoelectric properties and the like deteriorate. The ratio of the metal dopant to 1 mol of Pb in the Pb source of the PZT precursor is more preferably 0.005 mol to 0.01 mol.

Next, a method of preparing a PZT-based ferroelectric thin film-forming composition according to an embodiment of the invention will be described. First, the above-described Pb compound and the like of the PZT precursor are prepared and weighed at ratios for obtaining the desired metal atomic ratio, respectively. The weighed PZT precursor, a diol, and water are poured into a reaction vessel and mixed with each other, followed by reflux and reaction, preferably, in a nitrogen atmosphere at a temperature of 130° C. to 175° C. for 0.5 hours to 3 hours. As a result, a synthetic solution is prepared. After reflux, it is preferable that a solvent be removed using a method such as atmospheric distillation or distillation under reduced pressure. In addition, when a stabilizer such as acetyl acetone is added, it is preferable that the stabilizer be added to the synthetic solution after the solvent removal, followed by reflux in a nitrogen atmosphere at a temperature of 130° C. to 175° C. for 0.5 hours to 5 hours. Next, by being left to stand at room temperature, the synthetic solution is cooled to room temperature (25° C.).

A linear monoalcohol is added to the cooled synthetic solution to prepare a sol-gel solution. At this time, the concentration of the PZT precursor in 100 wt % of the composition is adjusted to be 17 wt % to 35 wt % in terms oxides, and the ratio of the diol to 100 wt % of the composition is adjusted to be 16 wt % to 56 wt %. In addition, it is preferable that a solvent other than diol be added to the sol-gel solution. Next, the sol-gel solution is re-refluxed in a predetermined atmosphere such as a nitrogen atmosphere at a temperature of 100° C. to 175° C. for 0.5 hours to 10 hours. When an organic dopant containing a polar solvent such as a formamide-based solvent is added, it is preferable that the organic dopant be added together with a solvent (for example, alcohol) other than diol.

Next, one of the polyvinyl pyrrolidones and the polyethylene glycol, which has a ratio of 0.01 mol to 0.25 mol with respect to 1 mol of the PZT precursor in terms of monomer, is added to the sol-gel solution to be uniformly dispersed in the sol-gel solution. As a result, the PZT-based ferroelectric thin film-forming composition according to the embodiment is obtained.

After the preparation of the composition, it is preferable that particles be removed from the composition by filtration or the like such that the number of particles having a particle size of 0.5 μm or greater (preferably 0.3 μm or greater and more preferably 0.2 μm or greater) be less than or equal to 50 particles per 1 mL of the composition. When the number of particles having a particle size of 0.5 μm or greater in the composition is more than 50 particles per 1 mL of the composition, long-term storage stability deteriorates. The lower the number of particles having a particle size of 0.5 μm or greater in the composition, the better. In particular, the number of particles is preferably less than or equal to 30 particles per 1 mL of the composition.

A method of treating the composition after adjusting the number of particles to be in the above-described range is not particularly limited. For example, the following method may be used. A first method is a filtration method of supplying pressure with a syringe using a commercially available membrane filter having a pore size of 0.2 μm. A second method is a pressure filtration method in which a commercially available membrane filter having a pore size of 0.05 μm is combined with a pressure tank. A third method is a circulation filtration method in which the filter used in the second method is combined with a solution circulating tank.

In all the methods, a particle capture rate by the filter varies depending on a supply pressure of the composition. It is generally known that, the lower the pressure, the higher the capture rate. Particularly in the first method or the second method, in order to realize the condition that the number of particles having a particle size of 0.5 μm or greater is less than or equal to 50 particles per 1 mL of the composition, it is preferable that the composition be made to pass extremely slowly through the filter at a low pressure.

A method of forming a PZT-based ferroelectric thin film according to an embodiment of the invention will be described. This forming method is a method of forming a ferroelectric thin film using a sol-gel method. As a raw material solution, the above-described PZT-based ferroelectric thin film-forming composition according to the embodiment or a PZT-based ferroelectric thin film-forming composition prepared using the above-described method according to the embodiment is used.

First, the PZT-based ferroelectric thin film-forming composition is coated on a substrate to form a coating film (gel film) having a desired thickness. The coating method is not particularly limited, and examples thereof include spin coating, dip coating, liquid source misted chemical deposition (LSMCD), and electrostatic spray coating. As a substrate used to form a ferroelectric thin film, a heat-resistant substrate, such as a silicon substrate or a sapphire substrate, on which a lower electrode is formed is used. The lower electrode which is formed on the substrate is formed of a material, such as Pt, TiO_{X}, Ir, or Ru, which has conductivity and is not reactive with the ferroelectric thin film. For example, the lower electrode can have a two-layer structure in which a TiO_{X} film and a Pt film are formed in this order from the substrate side. Specific examples of the TiO_{X} film include a TiO₂ film. Further, when a silicon substrate is used as the substrate, a SiO₂ film can be formed on the substrate surface.

After the coating film is formed on the substrate, this coating film is pre-baked and then baked to be crystallized. Pre-baking is performed using a hot plate or rapid thermal annealing (RTA) under a predetermined condition. It is preferable that pre-baking be performed in the air, in an oxygen atmosphere or in a water vapor-containing atmosphere in order to remove a solvent and to thermally decompose or hydrolyze a metal compound to be transformed into a complex oxide. Even during heating in the air, moisture required for hydrolysis is sufficiently secured with moisture in the air. Before pre-baking, particularly in order to remove low-boiling-point components or adsorbed water molecules, a low-temperature heat treatment may be performed using a hot plate at a temperature of 70° C. to 90° C. for 0.5 minutes to 5 minutes.

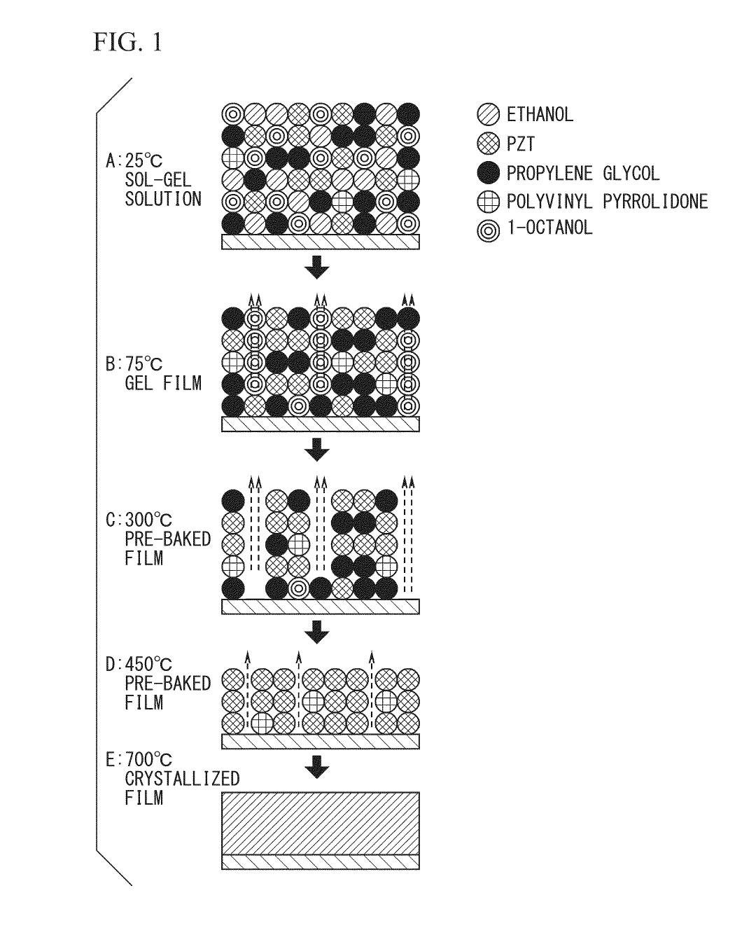

For the purpose of sufficiently removing a solvent and the like to further enhance the effect of suppressing voids or cracks or to promote the densification of a film structure, it is preferable that two-stage pre-baking be performed while changing a temperature increase rate and a heating holding temperature. During the two-stage pre-baking, the substrate is held at 250° C. to 300° C. for 3 minutes to 10 minutes in the first stage and is held at 400° C. to 500° C. for 3 minutes to 10 minutes in the second stage. In addition, it is preferable that a temperature increase rate from room temperature to the pre-baking temperature of the first stage be relatively low at 2.5° C./sec to 5° C./sec; and that a temperature increase rate from the pre-baking temperature of the first stage to the pre-baking temperature of the second stage be relatively high at 30° C./sec to 100° C./sec. As illustrated in FIGS. 1A to 1D, according to the study of Scherer et al., a model is proposed in which liquid inside a gel film is raised to the vicinity of the surface by a capillary force, and the gel is dried. That is, the linear monoalcohol having 6 to 12 carbon chains (for example, 1-octanol having 8 carbon chains), which has high surface tension, low affinity to the PZT precursor materials, and low steam pressure, is added to the sol-gel solution which is the composition according to the embodiment (FIG. 1A). Therefore, by slowly heating the substrate from room temperature to the pre-baking temperature of the first stage, 1-octanol in the gel film is raised to the gel film surface by a capillary force to be evaporated (FIG. 1B), and thus appropriate gaps are formed (FIG. 1C). Next, by relatively rapidly heating the substrate from the pre-baking temperature of the first stage to the pre-baking temperature of the second stage, propylene glycol and polyvinyl pyrrolidone are gasified and rapidly evaporated through the gaps. Therefore, diamond-like carbon obtained by propylene glycol being carbonized is not formed inside the film, and a dense pre-baked film having no diamond-like carbon inside is formed (FIG. 1D). As a result, a dense crystallized film having no voids inside is formed by baking (FIG. 1E).

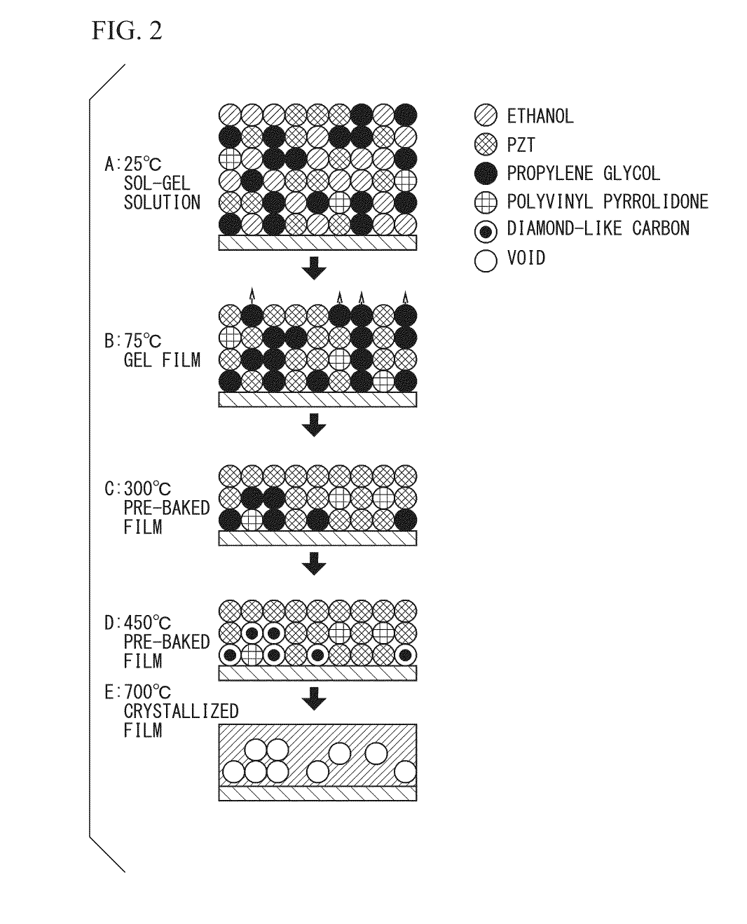

On the other hand, in the related art, as illustrated in FIGS. 2A to 2D, even when a substrate is slowly heated from room temperature to the pre-baking temperature of the first stage, there is no solvent, such as 1-octanol, which is raised to the gel film surface by a capillary force to be evaporated (FIG. 2A). Therefore, gaps are not formed inside the pre-baked film. In addition, even when propylene glycol is evaporated in the vicinity of the surface of the gel film or the pre-baked film, an exit of gas is removed by the rearrangement of particles (FIGS. 2B and 2C). Accordingly, even when the substrate is relatively rapidly heated from the pre-baking temperature of the first stage to the pre-baking temperature of the second stage, propylene glycol inside the film is carbonized, and thus diamond-like carbon is formed inside the pre-baked film (FIG. 2D). This diamond-like carbon causes the formation of voids (FIG. 2E) inside the crystallized film after baking.

The reason for limiting the pre-baking temperature of the first stage to be 250° C. to 300° C. is as follows. When the pre-baking temperature is lower than the lower limit, the heat decomposition of the precursor materials is insufficient, and thus cracking is likely to occur. When the pre-baking temperature is higher than the upper limit, the precursor materials of an upper portion of the substrate are decomposed before the precursor materials in the vicinity of the substrate are completely decomposed. As a result, since organic materials remain in the vicinity of the substrate, voids are likely to be formed. In addition, the reason for limiting the pre-baking time of the first stage to be 3 minutes to 10 minutes is as follows. When the pre-baking time is shorter than the lower limit, the decomposition of the precursor materials is not sufficiently progressed. When the pre-baking time is longer than the upper limit, the process time is increased, and productivity deteriorates. In addition, the reason for limiting the pre-baking temperature of the second stage to be 400° C. to 450° C. is as follows. When the pre-baking temperature is lower than the lower limit, residual organic materials remaining in the precursor materials are not completely removed, and thus the film is not sufficiently densified. When the pre-baking temperature is higher than the upper limit, crystallization is progressed, and it is difficult to control the orientation. In addition, the reason for limiting the pre-baking time of the second stage to be 3 minutes to 10 minutes is as follows. When the pre-baking time is shorter than the lower limit, residual organic materials are not sufficiently removed, strong stress is generated during crystallization, and thus the peeling or cracking of the film is likely to occur. When the pre-baking time is longer than the upper limit, the process time is increased, and productivity deteriorates.

In the composition used in this forming method, as described above, the amount of polyvinyl pyrrolidone and the like added is small, and a gel from which organic materials can be easily removed is formed. Therefore, even when a relatively thick coating film is pre-baked, one-stage pre-baking can be performed, and thus production efficiency can be improved. When one-stage pre-baking is performed as pre-baking process, it is preferable that the temperature be 400° C. to 500° C.; and that the holding time at the temperature be 1 minute to 5 minutes. In addition, the composition to be used has a high effect of suppressing cracking in spite that the amount of polyvinyl pyrrolidone and the like added is small. Therefore, even when a relatively thick coating film is pre-baked, it is not necessary that the temperature increase rate be greatly decreased, and production efficiency is high. The temperature increase rate from a temperature in a range from room temperature to 200° C., to the pre-baking temperature is preferably 10° C./sec to 100° C./sec.

In addition, the coating process of the composition to the pre-baking process can be repeated multiple times until a film having a predetermined thickness is obtained, and, finally, baking can be performed in a batch process. In this forming method, the above-described composition according to the embodiment and the like are used as the raw material solution. Therefore, since a thick film having several hundreds of nanometers can be formed for each coating process, the number of the repeated processes can be reduced.

Baking is the process for baking the pre-baked coating film at a crystallization temperature or higher to be crystallized. As a result, a ferroelectric thin film is obtained. As a baking atmosphere in this crystallization process, O₂, N₂, Ar, N₂O, H₂, or a mixed gas thereof is preferable. Baking is performed by holding the pre-baked coating film preferably at 600° C. to 700° C. for 1 minute to 5 minutes. Baking may be performed by rapid thermal annealing (RTA). When baking is performed by RTA, a temperature increase rate thereof is preferably 2.5° C./sec to 100° C./sec.

Through the above-described processes, the PZT-based ferroelectric thin film is obtained. In this ferroelectric thin film, the number of processes during film formation is small. Moreover, in spite that the thick film is relatively simply obtained, the amount of cracks is extremely small, and a dense film structure is obtained. Therefore, electrical properties are extremely superior.

Accordingly, the PZT-based ferroelectric thin film obtained using the above-described method according to the embodiment can be desirably used as a constituent material (electrode) of a composite electronic component such as a thin film capacitor, a capacitor, an IPD, a DRAM memory capacitor, a laminated capacitor, a gate insulator of a transistor, a non-volatile memory, a pyroelectric infrared detecting element, a piezoelectric element, an electro-optic element, an actuator, a resonator, an ultrasonic motor, or an LC noise filter element.

### EXAMPLES

Next, Examples of the invention and Comparative Examples will be described in detail.

### Example 1

First, as the PZT precursor, lead acetate trihydrate (Pb source), titanium tetraisopropoxide (Ti source), and zirconium tetrabutoxide (Zr source) were weighed such that a metal atomic ratio (Pb/Zr/Ti) was 115/52/48. These materials were added to a mixed solution of propylene glycol (diol), acetyl acetone, and ultrapure water (water) in a reaction vessel to react with each other. As a result, a synthetic solution was prepared. In this case, 2 mol of ultrapure water (water) was added with respect to 1 mol of the PZT precursor. After the synthetic solution was refluxed in a nitrogen atmosphere at a temperature of 150° C. for 1 hour, a unnecessary solvent was removed from the synthetic solution by distillation under reduced pressure such that the concentration of the PZT precursor in 100 wt % of the synthetic solution was 35% in terms of oxides. In this case, the concentration of the PZT precursor in the synthetic solution in terms of oxides refers to the concentration of metal oxides in 100 wt % of the synthetic solution which was calculated under the assumption that all the metal elements contained in the synthetic solution were converted into desired oxides.

Next, after the synthetic solution was left to stand at room temperature to be cooled to 25° C., 1-octanol (linear monoalcohol having 8 carbon chains), ethanol (solvent), and N-methyl formamide (polar solvent) were added thereto. As a result, a sol-gel solution was obtained in which the concentration of the PZT precursor in 100 wt % of the sol-gel solution was 25 wt % in terms of oxides. In this case, the concentration of the PZT precursor in the sol-gel solution in terms of oxides refers to the concentration of metal oxides in 100 wt % of the synthetic solution which was calculated under the assumption that all the metal elements contained in the sol-gel solution were converted into desired oxides.

Next, 0.025 mol of polyvinyl pyrrolidone (k value=30) was added to the sol-gel solution with respect to 1 mol of the PZT precursor, followed by stirring at room temperature (25° C.) for 24 hours. As a result, a composition used to form a PZT-based ferroelectric thin film was obtained. This composition was filtered through a commercially available membrane filter having a pore size of 0.05 μm by supplying a pressure thereto with a syringe. The number of particles having a particle size of 0.5 μm or greater was 3 per 1 mL of the solution. In addition, the concentration of the PZT precursor in 100 wt % of the composition was 25 wt % in terms of oxides. In addition, 0.6 wt % of 1-octanol (linear monoalcohol having 8 carbon chains) was contained with respect to 100 wt % of the composition. Further, 36 wt % of propylene glycol (diol) was contained with respect to 100 wt % of the composition.

The obtained composition was dripped on a Pt film (lower electrode) of a Si/SiO₂/TiO₂/Pt substrate set which was on a spin coater, followed by spin-coating at a rotating speed of 1800 rpm for 1 minute. As a result, a coating film (gel film) was formed on the substrate.

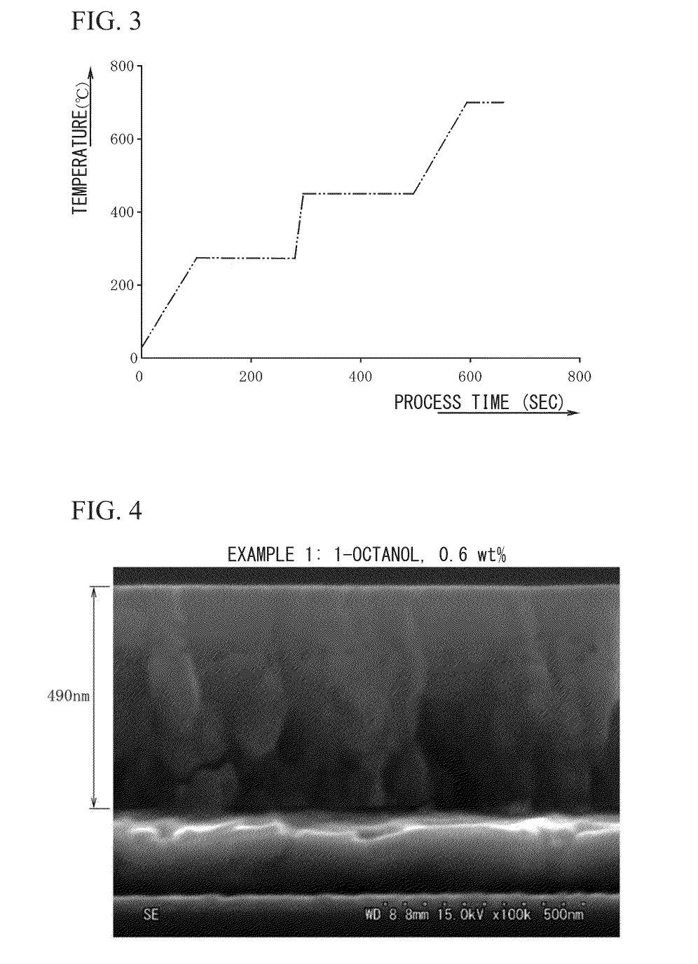

Further, the coating film which was formed on the substrate was two-stage pre-baking and baking according to a temperature profile illustrated in FIG. 3. As a result, a PZT-based ferroelectric thin film was formed. Specifically, first, before two-stage pre-baking and baking, the substrate on which the coating film was formed was held in the air at a temperature of 75° C. for 1 minute using a hot plate. As a result, low-boiling-point components and adsorbed water molecules were removed.

Next, the substrate was held on a hot plate at 300° C. for 5 minutes in the first-stage of pre-baking to hydrolyze the gel film. Next, the substrate was held on a hot plate at 450° C. for 5 minutes to completely remove residual fine organic materials remaining in the film. By repeating the same operation once more, a pre-baked film (PZT amorphous film) having a thickness of 400 nm was obtained. Further, as illustrated in FIG. 3, for baking, the pre-baked film was heated in an oxygen atmosphere from room temperature to 700° C. at a temperature increase rate of 10° C./sec and was held at 700° C. for 1 minute. As a result, a PZT-based ferroelectric thin film was formed on the lower electrode of the substrate.

### Example 2

A PZT-based ferroelectric thin film was formed with the same method as that of Example 1, except that 6.3 wt % of 1-octanol (linear monoalcohol having 8 carton chains) of Example 1 was contained with respect to 100 wt % of the composition.

### Example 3

A PZT-based ferroelectric thin film was formed with the same method as that of Example 1, except that 10 wt % of 1-octanol (linear monoalcohol having 8 carton chains) of Example 1 was contained with respect to 100 wt % of the composition.

### Example 4

A PZT-based ferroelectric thin film was formed with the same method as that of Example 2, except that 16 wt % of propylene glycol (diol) of Example 2 was contained with respect to 100 wt % of the composition.

### Example 5

A PZT-based ferroelectric thin film was formed with the same method as that of Example 2, except that 56 wt % of propylene glycol (diol) of Example 2 was contained with respect to 100 wt % of the composition.

### Example 6

A PZT-based ferroelectric thin film was formed with the same method as that of Example 2, except that 0.5 mol of ultrapure water (water) of Example 2 was added with respect to 1 mol of the PZT precursor.

### Example 7

A PZT-based ferroelectric thin film was formed with the same method as that of Example 2, except that 3 mol of ultrapure water (water) of Example 2 was added with respect to 1 mol of the PZT precursor.

### Example 8

A PZT-based ferroelectric thin film was formed with the same method as that of Example 2, except that 0.01 mol of polyvinyl pyrrolidone (k value=30) of Example 2 was added with respect to 1 mol of the PZT precursor.

### Example 9

A PZT-based ferroelectric thin film was formed with the same method as that of Example 2, except that 0.25 mol of polyvinyl pyrrolidone (k value=30) of Example 2 was added with respect to 1 mol of the PZT precursor.

### Example 10

A PZT-based ferroelectric thin film was formed with the same method as that of Example 2, except that, as the PZT precursor, lead acetate trihydrate (Pb source), lanthanum acetate 1.5 hydrate (La source), titanium tetraisopropoxide (Ti source), and zirconium tetrabutoxide (Zr source) were weighed, respectively, such that a metal atomic ratio (Pb/La/Zr/Ti) was 115/3/52/48. This PZT-based ferroelectric thin film was doped with La as a metal dopant.

### Example 11

A PZT-based ferroelectric thin film was formed with the same method as that of Example 2, except that, as the PZT precursor, lead acetate trihydrate (Pb source), manganese 2-ethylhexanoate (Mn source), titanium tetraisopropoxide (Ti source), and zirconium tetrabutoxide (Zr source) were weighed, respectively, such that a metal atomic ratio (Pb/Mn/Zr/Ti) was 115/1/52/48. This PZT-based ferroelectric thin film was doped with Mn as a metal dopant.

### Example 12

A PZT-based ferroelectric thin film was formed with the same method as that of Example 2, except that, as the PZT precursor, lead acetate trihydrate (Pb source), niobium pentaethoxide (Nb source), titanium tetraisopropoxide (Ti source), and zirconium tetrabutoxide (Zr source) were weighed, respectively, such that a metal atomic ratio (Pb/Nb/Zr/Ti) was 115/0.2/52/48. This PZT-based ferroelectric thin film was doped with Nb as a metal dopant.

### Example 13

A PZT-based ferroelectric thin film was formed with the same method as that of Example 2, except that 1-heptanol (linear monoalcohol having 7 carbon chains) was used instead of 1-octanol (linear monoalcohol having 8 carbon chains) of Example 2.

### Example 14

A PZT-based ferroelectric thin film was formed with the same method as that of Example 2, except that 1-dodecanol (linear monoalcohol having 12 carbon chains) was used instead of 1-octanol (linear monoalcohol having 8 carbon chains) of Example 2.

### Example 15

A PZT-based ferroelectric thin film was formed with the same method as that of Example 2, except that 1-decanol (linear monoalcohol having 10 carbon chains) was used instead of 1-octanol (linear monoalcohol having 8 carbon chains) of Example 2.

### Example 16

A PZT-based ferroelectric thin film was formed with the same method as that of Example 10, except that the thickness of the ferroelectric thin film of Example 10 was changed from 460 nm to 380 nm.

### Example 17

A PZT-based ferroelectric thin film was formed with the same method as that of Example 10, except that the thickness of the ferroelectric thin film of Example 10 was changed from 460 nm to 400 nm.

### Example 18

A PZT-based ferroelectric thin film was formed with the same method as that of Example 10, except that the thickness of the ferroelectric thin film of Example 10 was changed from 460 nm to 420 nm.

### Example 19

A PZT-based ferroelectric thin film was formed with the same method as that of Example 2, except that 1-hexanol (linear monoalcohol having 6 carbon chains) was used instead of 1-octanol (linear monoalcohol having 8 carbon chains) of Example 2.

### Example 20

A PZT-based ferroelectric thin film was formed with the same method as that of Example 2, except that the concentration of the PZT precursor in 100 wt % of the composition of Example 2 was changed to 17 wt % in terms of oxides.

### Example 21

A PZT-based ferroelectric thin film was formed with the same method as that of Example 2, except that the concentration of the PZT precursor in 100 wt % of the composition of Example 2 was changed to 35 wt % in terms of oxides.

### Comparative Example 1

A PZT-based ferroelectric thin film was formed with the same method as that of Example 1, except that 1-octanol (linear monoalcohol having 8 carton chains) of Example 1 was not added.

### Comparative Example 2

A PZT-based ferroelectric thin film was formed with the same method as that of Example 1, except that 0.3 wt % of 1-octanol (linear monoalcohol having 8 carton chains) of Example 1 was contained with respect to 100 wt % of the composition.

### Comparative Example 3

A PZT-based ferroelectric thin film was formed with the same method as that of Example 1, except that 12 wt % of 1-octanol (linear monoalcohol having 8 carton chains) of Example 1 was contained with respect to 100 wt % of the composition.

### Comparative Example 4

A PZT-based ferroelectric thin film was formed with the same method as that of Example 2, except that 1-pentanol (linear monoalcohol having 5 carbon chains) was used instead of 1-octanol (linear monoalcohol having 8 carbon chains) of Example 2.

### Comparative Example 5

A PZT-based ferroelectric thin film was formed with the same method as that of Example 2, except that 1-tridecanol (linear monoalcohol having 13 carbon chains) was used instead of 1-octanol (linear monoalcohol having 8 carbon chains) of Example 2.

### Comparative Example 6

A PZT-based ferroelectric thin film was formed with the same method as that of Example 2, except that the concentration of the PZT precursor in 100 mass of the composition of Example 2 was changed to 16 wt % in terms of oxides.

### Comparative Example 7

A PZT-based ferroelectric thin film was formed with the same method as that of Example 2, except that the concentration of the PZT precursor in 100 mass of the composition of Example 2 was changed to 36 wt % in terms of oxides.

### Comparative Example 8

A PZT-based ferroelectric thin film was formed with the same method as that of Example 2, except that 15 wt % of propylene glycol (diol) of Example 2 was contained with respect to 100 wt % of the composition.

### Comparative Example 9

A PZT-based ferroelectric thin film was formed with the same method as that of Example 2, except that 57 wt % of propylene glycol (diol) of Example 2 was contained with respect to 100 wt % of the composition.

### Comparative Example 10

A PZT-based ferroelectric thin film was formed with the same method as that of Example 2, except that 0.4 mol of ultrapure water (water) of Example 2 was added with respect to 1 mol of the PZT precursor.

### Comparative Example 11

A PZT-based ferroelectric thin film was formed with the same method as that of Example 2, except that 3.1 mol of ultrapure water (water) of Example 2 was added with respect to 1 mol of the PZT precursor.

### Comparative Example 12

A PZT-based ferroelectric thin film was formed with the same method as that of Example 2, except that polyvinyl pyrrolidone (k value=30) of Example 2 was not added.

### Comparative Example 13

A PZT-based ferroelectric thin film was formed with the same method as that of Example 2, except that 0.26 mol of polyvinyl pyrrolidone (k value=30) of Example 2 was added with respect to 1 mol of the PZTI precursor.

### Comparative Test 1 and Evaluation

Regarding each of the PZT-based ferroelectric thin films of Examples 1 to 21 and Comparative Examples 1 to 13, the film thickness, whether or not cracking occurred, the leakage current density, and the refractive index were investigated. Specifically, the film thickness was measured by measuring the thickness (total thickness) of a cross-section of the ferroelectric thin film using a spectroscopic ellipsometer (M-2000D1, manufactured by J.A. Woollam Co. Inc.). In addition, regarding whether or not cracking occurred, an SEM image of a film surface and a film cross-section was obtained with the scanning electron microscope used in the film thickness measurement, and whether or not cracking occurred was determined by observing this SEM image. A state where no cracks were observed is represented by “No Cracks”, and a state where cracks were observed is represented by “Cracks Formed”. In addition, the leakage current density was measured using a ferroelectric tester (TF-Analyzer 2000, manufactured by aixACCT Systems GmbH) after forming a Pt upper electrode having a size of 100 μm×100 μm and a thickness of 200 nm on the film using a sputtering method and performing damage recovery annealing by RTA in an oxygen atmosphere for 1 minute. Further, the refractive index was measured and calculated using a spectroscopic ellipsometer. The results are shown in Tables 1 and 2.

TABLE 1

| | Linear | | | | | | | | | | |
|---|---|---|---|---|---|---|---|---|---|---|---|
| | Monoalcohol | | Concentration | | | | | | | Leakage | |
| | | Content | of PZT- | Existence and | | Ultrapure | | Film | | Current | |
| | Carbon | Ratio | Precursor | Kind of Metal | Diol | Water | PVP | Thickness | | Density | Refractive |
| | Chains | (wt %) | (wt %) | Dopant | (wt %) | (mol) | (mol) | (nm) | Cracking | (A/cm²) | Index |
| Ex. 1 | 8 | 0.6 | 25 | None | 36 | 2 | 0.025 | 490 | No Cracks | 1.2 × 10⁻⁶ | 2.51 |
| Ex. 2 | 8 | 6.3 | 25 | None | 36 | 2 | 0.025 | 460 | No Cracks | 1.0 × 10⁻⁶ | 2.52 |
| Ex. 3 | 8 | 10 | 25 | None | 36 | 2 | 0.025 | 360 | No Cracks | 1.2 × 10⁻⁶ | 2.52 |
| Ex. 4 | 8 | 6.3 | 25 | None | 16 | 2 | 0.025 | 400 | No Cracks | 2.0 × 10⁻⁶ | 2.51 |
| Ex. 5 | 8 | 6.3 | 25 | None | 56 | 2 | 0.025 | 470 | No Cracks | 3.2 × 10⁻⁶ | 2.51 |
| Ex. 6 | 8 | 6.3 | 25 | None | 36 | 0.5 | 0.025 | 460 | No Cracks | 1.4 × 10⁻⁶ | 2.49 |
| Ex. 7 | 8 | 6.3 | 25 | None | 36 | 3 | 0.025 | 460 | No Cracks | 1.7 × 10⁻⁶ | 2.47 |
| Ex. 8 | 8 | 6.3 | 25 | None | 36 | 2 | 0.01 | 420 | No Cracks | 1.2 × 10⁻⁶ | 2.52 |
| Ex. 9 | 8 | 6.3 | 25 | None | 36 | 2 | 0.25 | 500 | No Cracks | 3.9 × 10⁻⁶ | 2.52 |
| Ex. 10 | 8 | 6.3 | 25 | La | 36 | 2 | 0.025 | 460 | No Cracks | 1.2 × 10⁻⁷ | 2.55 |
| Ex. 11 | 8 | 6.3 | 25 | Mn | 36 | 2 | 0.025 | 460 | No Cracks | 2.3 × 10⁻⁷ | 2.46 |
| Ex. 12 | 8 | 6.3 | 25 | Nb | 36 | 2 | 0.025 | 460 | No Cracks | 8.9 × 10⁻⁸ | 2.59 |
| Ex. 13 | 7 | 6.3 | 25 | None | 36 | 2 | 0.025 | 460 | No Cracks | 1.9 × 10⁻⁶ | 2.49 |
| Ex. 14 | 12 | 6.3 | 25 | None | 36 | 2 | 0.025 | 500 | No Cracks | 2.5 × 10⁻⁶ | 2.45 |
| Ex. 15 | 10 | 6.3 | 25 | None | 36 | 2 | 0.025 | 460 | No Cracks | 1.2 × 10⁻⁶ | 2.50 |
| Ex. 16 | 8 | 6.3 | 25 | None | 36 | 2 | 0.025 | 380 | No Cracks | 2.3 × 10⁻⁶ | 2.49 |
| Ex. 17 | 8 | 6.3 | 25 | None | 36 | 2 | 0.025 | 400 | No Cracks | 1.9 × 10⁻⁶ | 2.50 |
| Ex. 18 | 8 | 6.3 | 25 | None | 36 | 2 | 0.025 | 420 | No Cracks | 2.9 × 10⁻⁶ | 2.51 |
| Ex. 19 | 6 | 6.3 | 25 | None | 36 | 2 | 0.025 | 400 | No Cracks | 2.0 × 10⁻⁶ | 2.51 |
| Ex. 20 | 8 | 6.3 | 17 | None | 36 | 2 | 0.025 | 360 | No Cracks | 1.6 × 10⁻⁶ | 2.52 |
| Ex. 21 | 8 | 6.3 | 35 | None | 36 | 2 | 0.025 | 560 | No Cracks | 2.7 × 10⁻⁶ | 2.45 |

TABLE 2

| | Linear | | | | | | | | | | |
|---|---|---|---|---|---|---|---|---|---|---|---|
| | Monoalcohol | | Concentration | | | | | | | Leakage | |
| | | Content | of PZT- | Existence and | | Ultrapure | | Film | | Current | |
| | Carbon | Ratio | Precursor | Kind of Metal | Diol | Water | PVP | Thickness | | Density | Refractive |
| | Chains | (wt %) | (wt %) | Dopant | (wt %) | (mol) | (mol) | (nm) | Cracking | (A/cm²) | Index |
| Comp. | 8 | 0 | 25 | None | 36 | 2 | 0.025 | 540 | Cracks | 4.3 × 10⁻² | 2.35 |
| Ex. 1 | | | | | | | | | Formed | | |
| Comp. | 8 | 0.3 | 25 | None | 36 | 2 | 0.025 | 500 | No Cracks | 1.2 × 10⁻⁶ | 2.41 |
| Ex. 2 | | | | | | | | | | | |
| Comp. | 8 | 12 | 25 | None | 36 | 2 | 0.025 | 280 | No Cracks | 4.2 × 10⁻⁵ | 2.42 |
| Ex. 3 | | | | | | | | | | | |
| Comp. | 5 | 6.3 | 25 | None | 36 | 2 | 0.025 | 500 | Cracks | 4.9 × 10⁻² | 2.38 |
| Ex. 4 | | | | | | | | | Formed | | |
| Comp. | 13 | 6.3 | 25 | None | 36 | 2 | 0.025 | 240 | No Cracks | 4.9 × 10⁻⁴ | 2.43 |
| Ex. 5 | | | | | | | | | | | |
| Comp. | 8 | 6.3 | 16 | None | 36 | 2 | 0.025 | 290 | No Cracks | 1.7 × 10⁻⁶ | 2.50 |
| Ex. 6 | | | | | | | | | | | |
| Comp. | 8 | 6.3 | 36 | None | 36 | 2 | 0.025 | 600 | Cracks | 2.9 × 10⁻³ | 2.38 |
| Ex. 7 | | | | | | | | | Formed | | |
| Comp. | 8 | 6.3 | 25 | None | 15 | 2 | 0.025 | 410 | Cracks | 4.5 × 10⁻³ | 2.48 |
| Ex. 8 | | | | | | | | | Formed | | |
| Comp. | 8 | 6.3 | 25 | None | 57 | 2 | 0.025 | 600 | No Cracks | 9.4 × 10⁻⁵ | 2.43 |
| Ex. 9 | | | | | | | | | | | |
| Comp. | 8 | 6.3 | 25 | None | 36 | 0.4 | 0.025 | 500 | No Cracks | 9.9 × 10⁻⁵ | 2.40 |
| Ex. 10 | | | | | | | | | | | |
| Comp. | 8 | 6.3 | 25 | None | 36 | 3.1 | 0.025 | 450 | Cracks | 3.9 × 10⁻² | 2.50 |
| Ex. 11 | | | | | | | | | Formed | | |
| Comp. | 8 | 6.3 | 25 | None | 36 | 2 | 0 | 400 | Cracks | 5.2 × 10⁻³ | 2.51 |
| Ex. 12 | | | | | | | | | Formed | | |
| Comp. | 8 | 6.3 | 25 | None | 36 | 2 | 0.26 | 500 | No Cracks | 7.2 × 10⁻⁴ | 2.43 |
| Ex. 13 | | | | | | | | | | | |

Tables 1 and 2 clearly show the following results. In Comparative Examples 1, 4, 7, 8, 11, and 12, cracking occurred in the films; whereas in Comparative Examples 2, 3, 5, 6, 9, 10, and 13 and Examples 1 to 21, cracking did not occur. In addition, in Comparative Examples 1 and 2, the refractive indices of the films were low at 2.35 to 2.41; whereas, in Examples 1 to 21, the refractive indices of the films were high at 2.45 to 2.52. The reason is presumed to be as follows. In Examples 1 to 21 in which 0.6 wt % to 10 wt % of the linear monoalcohol was added with respect to 100 wt % of the composition, organic materials were effectively removed from the inside of the film. Further, even when the thickness of a single layer was sufficiently large, the film was able to crystallized by performing a baking process once, and thus a crack-free and dense film was able to be formed. In addition, it was found that the leakage current densities of the films of Examples 1 to 21 were reduced by one digit or two or more digits as compared to those of the films of Comparative Examples 1, 3 to 5, and 7 to 13. In Comparative Example 6, since the film thickness was small at 290 nm, cracking did not occur in the film, the refractive index of the film was high, and the leakage current density of the film was low. In addition, in Comparative Example 6, since the concentration of the PZT precursor was excessively low and a film having a sufficient thickness was not able to be formed, the film thickness was small.

### Example 22

A PZT-based ferroelectric thin film was formed with the same method as that of Example 1, except that the amount of 1-octanol (linear monoalcohol having 8 carton chains) of Example 1 added with respect to 100 wt % of the composition was changed to 6.3 wt %.

### Comparative Test 2 and Evaluation

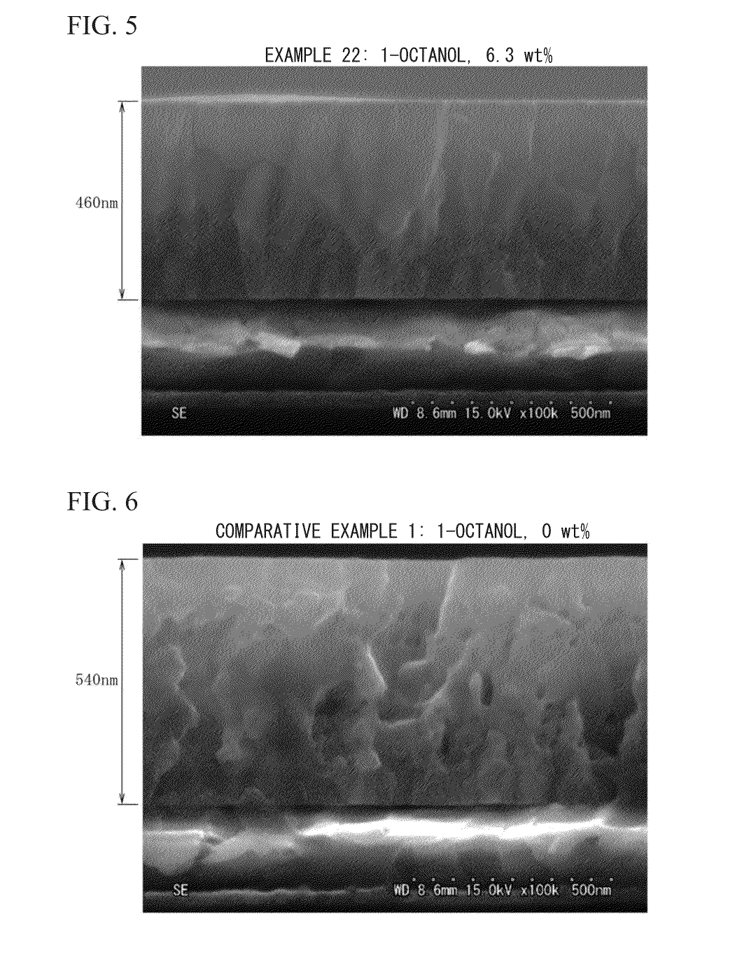

Cross-sections of the PZT-based ferroelectric thin films formed in Examples 1 and 22 and Comparative Examples 1 were observed using an SEM to check whether or not voids were formed. The results are shown in FIGS. 4 to 6.

As clearly seen from FIGS. 4 to 6, in the PZT-based ferroelectric thin film of Comparative Example 1, a relatively large amount of voids were observed (FIG. 6). On the other hand, in the PZT-based ferroelectric thin film of Example 1, substantially no voids were observed, and in the PZT-based ferroelectric thin film of Example 22, voids were not observed at all. It was found from the result that the PZT-based ferroelectric thin films of Examples 1 and 22 had an extremely dense structure.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### INDUSTRIAL APPLICABILITY

The present invention can be used for manufacturing a constituent material (electrode) of a composite electronic component such as a thin film capacitor, a capacitor, an IPD, a DRAM memory capacitor, a laminated capacitor, a gate insulator of a transistor, a non-volatile memory, a pyroelectric infrared detecting element, a piezoelectric element, an electro-optic element, an actuator, a resonator, an ultrasonic motor, or an LC noise filter element.

1. A PZT-based ferroelectric thin film-forming composition used to form a PZT-based ferroelectric thin film, the composition comprising:
a PZT precursor;
a diol;
one of polyvinyl pyrrolidones and a polyethylene glycol;
water; and
a linear monoalcohol having 6 to 12 carbon chains,
a concentration of the PZT precursor in 100 wt % of the composition is 17 wt % to 35 wt % in terms of oxides,
a ratio of the diol to 100 wt % of the composition is 16 wt % to 56 wt %,
a ratio of the one of the polyvinyl pyrrolidones and the polyethylene glycol to 1 mol of the PZT precursor is 0.01 mol to 0.25 mol,
a ratio of the water to 1 mol of the PZT precursor is 0.5 mol to 3 mol, and
a ratio of the linear monoalcohol to 100 wt % of the composition is 0.6 wt % to 10 wt %.

2. A method of preparing a PZT-based ferroelectric thin film-forming composition, the method comprising:
a step of mixing a PZT precursor which has a concentration of 17 wt % to 35 wt % in terms of oxides in 100 wt % of the composition, a diol which has a ratio of 16 wt % to 56 wt % with respect to 100 wt % of the composition, and water which has a ratio of 0.5 mol to 3 mol with respect to 1 mol of the PZT precursor to react with each other to prepare a synthetic solution;
a step of refluxing the synthetic solution at a temperature of 130° C. to 175° C. for 0.5 hours to 3 hours;
a step of adding a linear monoalcohol having 6 to 12 carbon chains, which has a ratio of 0.6 wt % to 10 wt % with respect to 100 wt % of the composition, to the refluxed synthetic solution to prepare a sol-gel solution;
a step of re-refluxing the sol-gel solution at a temperature of 100° C. to 175° C. for 0.5 hours to 10 hours; and
a step of adding one of polyvinyl pyrrolidones and a polyethylene glycol, which has a ratio of 0.01 mol to 0.25 mol with respect to 1 mol of the PZT precursor, to the re-refluxed sol-gel solution to be uniformly dispersed in the sol-gel solution.

3. The PZT-based ferroelectric thin film-forming composition according to claim 1,
wherein the diol is one of a propylene glycol and an ethylene glycol.

4. The method of preparing a PZT-based ferroelectric thin film-forming composition according to claim 2,
wherein the diol is one of a propylene glycol and an ethylene glycol.

5. A method of forming a PZT-based ferroelectric thin film, the method comprising:
coating the PZT-based ferroelectric thin film-forming composition
comprising:
a PZT precursor;
a diol;
one of polyvinyl pyrrolidones and a polyethylene glycol;
water, and
a linear monoalcohol having 6 to 12 carbon chains,
a concentration of the PZT precursor in 100 wt % of the composition is 17 wt % to 35 wt % in terms of oxides,
a ratio of the diol to 100 wt % of the composition is 16 wt % to 56 wt %,
a ratio of the one of the polyvinyl pyrrolidones and the polyethylene glycol to 1 mol of the PZT precursor is 0.01 mol to 0.25 mol,
a ratio of the water to 1 mol of the PZT precursor is 0.5 mol to 3 mol, and
a ratio of the linear monoalcohol to 100 wt % of the composition is 0.6 wt % to 10 wt %, or a PZT-based ferroelectric thin film-forming composition prepared using the method according to claim 2 on a lower electrode of a substrate;
pre-baking the composition; and
baking the composition to be crystallized and to form a thin film on the lower electrode.

6. A complex electronic component comprising:
a PZT-based ferroelectric thin film which is formed using the method according to claim 5,
wherein the complex electronic component is one of a thin film capacitor, a capacitor, an IPD, a DRAM memory capacitor, a laminated capacitor, a gate insulator of a transistor, a non-volatile memory, a pyroelectric infrared detecting element, a piezoelectric element, an electro-optic element, an actuator, a resonator, an ultrasonic motor, and an LC noise filter element.

7. A method of forming a PZT-based ferroelectric thin film, the method comprising:
coating the PZT-based ferroelectric thin film-forming composition according to claim 1 or a PZT-based ferroelectric thin film-forming composition prepared using the method comprising:
a step of mixing a PZT precursor which has a concentration of 17 wt % to 35 wt % in terms of oxides in 100 wt % of the composition, a diol which has a ratio of 16 wt % to 56 wt % with respect to 100 wt % of the composition, and water which has a ratio of 0.5 mol to 3 mol with respect to 1 mol of the PZT precursor to react with each other to prepare a synthetic solution;
a step of refluxing the synthetic solution at a temperature of 130° C. to 175° C. for 0.5 hours to 3 hours;
a step of adding a linear monoalcohol having 6 to 12 carbon chains, which has a ratio of 0.6 wt % to 10 wt % with respect to 100 wt % of the composition, to the refluxed synthetic solution to prepare a sol-gel solution;
a step of re-refluxing the sol-gel solution at a temperature of 100° C. to 175° C. for 0.5 hours to 10 hours; and
a step of adding one of polyvinyl pyrrolidones and a polyethylene glycol, which has a ratio of 0.01 mol to 0.25 mol with respect to 1 mol of the PZT precursor, to the re-refluxed sol-gel solution to be uniformly dispersed in the sol-gel solution,
on a lower electrode of a substrate;
pre-baking the composition; and
baking the composition to be crystallized and to form a thin film on the lower electrode.

8. A complex electronic component comprising:
a PZT-based ferroelectric thin film which is formed using the method according to claim 7,
wherein the complex electronic component is one of a thin film capacitor, a capacitor, an IPD, a DRAM memory capacitor, a laminated capacitor, a gate insulator of a transistor, a non-volatile memory, a pyroelectric infrared detecting element, a piezoelectric element, an electro-optic element, an actuator, a resonator, an ultrasonic motor, and an LC noise filter element.
